(19) United States
(12) Patent Application Publication
(10) Pub. No.: US 2007/0067740 A1
(43) Pub. Date: Mar. 22, 2007

(54) DRIVER TO CONFIGURE A USER INTERFACE AND METHOD THEREOF

(76) Inventors: Jung-soo Seo, Suwon-si (KR); Chong-ho Moon, Suwon-si (KR)

Correspondence Address: STANZIONE & KIM, LLP, 919 18TH STREET, N.W., SUITE 440, WASHINGTON, DC, 20006, US

(21) Appl. No.: 11/420,504

(22) Filed: May 26, 2006

(30) Foreign Application Priority Data
Sep. 16, 2005 (KR) 2005-87071

(51) Int. Cl. G06F 17/00

(52) U.S. Cl. 715/825; 715/810

(57) ABSTRACT

A driver configuring a user interface, a user interface apparatus and a method thereof. The method of configuring a user interface which provides a main window having at least one main menu and a popup window linked to each of the main menus and having at least one submenu includes: adding a submenu into a main window as the main menu when an option of adding is selected; deleting a selected submenu included in the main window as a main menu from the main window when an operation of deleting is selected; and restoring a current configuration of the main menu and the submenu to an initial configuration when an option of restoring is selected.

### CROSS-REFERENCE TO RELATED APPLICATIONS

This application claims the benefit of Korean Patent Application No. 2005-87071, filed on Sep. 16, 2005 in the Korean Intellectual Property Office, the disclosure of which is incorporated herein by reference in its entirety.

### BACKGROUND OF THE INVENTION

1. Field of the Invention

The present general inventive concept related to a driver to configure a user interface, a user interface apparatus and a method thereof; and more particularly, to a driver for to configure a user interface a user interface, apparatus and a method thereof to simply and rapidly use frequently used functions and to improve operation efficiency.

2. Description of the Related Art

A driver is normally installed in a host apparatus having a processor, a RAM and a storage medium, such as a personal computer, a notebook computer and a personal digital assistant (PDA) to control a peripheral device such as a printer, a scanner, a mouse, a wired/wireless network interface card, or a USB storage medium. The driver is a piece of software that enables a host apparatus to communicate with a peripheral device. That is, the driver recognizes the peripheral devices accessing the host apparatus through a wired or a wireless communication link and provides interfaces between the host apparatus and the peripheral devices. Also, the driver provides a user interface to set functions and driving methods of the peripheral devices. For example, a user can set various options for printing an image, i.e., a printing resolution or a printing direction through a user interface provided by a printer driver installed in a computer when the driver for the printer accesses the host apparatus of the printer. Therefore, it is very important to configure the user interface provided through a corresponding driver to provide convenience ways of using the supplementary functions and driving methods.

FIG. 1 is a structure chart of a conventional user interface.

Referring to FIG. 1, a user interface structure has a tree type structure and includes a main widow as a higher layer and a popup window as a lower layer. The main window includes n main menus 1 to n with n corresponding tabs 1 to n and the popup window has two submenus 2-1 and 2-2 with two corresponding tabs 2-1 and 2-2. Since the main menu and the submenu are hierarchically structured, the main menu must be activated in order to activate a corresponding submenu.

FIGS. 2A through 2C exemplary illustrate a conventional user interface for setting functions.

Referring to FIG. 2A, a main window 200 is provided as a user interface for setting functions of an image forming apparatus, and the main window 200 includes main menus of ‘Lay out’, ‘Paper’, ‘Graphic’ and ‘Extras’. A sub window for submenus is provided by clicking a tab of the corresponding main menu. FIG. 2A illustrates a sub window for ‘Graphic’ displayed when the tab of ‘Graphic’ is clicked.

If a user wants to set a ‘color intent’ option, the user must select and click several tabs and submenus as follows. At first, a “color adjust” B is clicked after the tab A of the ‘Graphic’ main menu in the main window 200 is selected. As a result, a popup window 250 is displayed as illustrated in FIG. 2B. As illustrated, the popup window 250 includes submenus ‘Properties’ and ‘Settings’ of the ‘color adjust’. Among the submenus in the popup windows 250, the user must select the ‘Settings (C)’ to set the ‘Color Intent (D)’.

As described above, the user must activate the popup window to set options of a submenu. When the target submenu is a frequently used menu, it is very time consuming and tedious to the user to set the corresponding option of the submenu. Therefore, operating efficiency thereof becomes degraded.

### SUMMARY OF THE INVENTION

The present general inventive concept provides a driver to configure a user interface, a user interface apparatus and a method thereof to simply and rapidly use frequently used functions and to improve operation efficiency.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of configuring a user interface providing a main window having at least one main menu and a popup window linked to each of the main menus having at least one submenu including adding a submenu into the main window as the main menu when an option of adding a submenu is selected and predetermined conditions are met.

The method may further include deleting a selected submenu included in the main window as a main menu from the main window when an operation of deleting is selected.

The method may further include restoring a current configuration of the main menu and the submenu to an initial configuration when an option of initializing is selected.

The number of the main menus in the main window may be variable.

The submenu may be not added to the main window as a main menu when a predetermined condition that the submenu is already in the main window is determined.

A failure of adding the submenu into the main window may be indicated to a user.

The option of adding a submenu may be selected by using a mouse, checking an option box or using a short-key.

The foregoing and/or other aspects and utilities of the present general inventive concept are also achieved by providing a driver configuring a user interface including a main window having at least one main menu and a popup window linked each of to the main menus and having at least one submenu, including an option of adding one or more of the at least one submenu into the main window as the main menu when the option of adding is selected.

The driver may further include an option of deleting a selected submenu added to the main window when the option of deleting is selected.

The driver may further include an option of restoring a current configuration of the main menu and the submenu to an initial configuration when the option of restoring is selected.

The driver may further include a storing unit for storing the initial configuration of the main menu and the submenu.

The number of the main menus in the main window may be variable.

The submenu may be not added into the main window if the submenu is determined to already be in the main window.

A failure of adding the submenu may be indicated to a user.

The option of adding may be selected by using a mouse, checking an option box or using a short-key.

The driver may be a printer driver.

The foregoing and/or other aspects and utilities of the present general inventive concept are also achieved by providing a method of adding a submenu as a main menu to a main window of a user interface of a printer driver, the method comprising: selecting an option of adding a select submenu among a plurality of submenus to a main window through an input device; reprogramming the selected submenu to be a main menu displayed on the main window if predetermined conditions are met, otherwise indicating that the selected submenu is not being added to the main window as a main menu together with the one or more predetermined conditions that were not met.

The foregoing and/or other aspects and utilities of the present general inventive concept are also achieved by providing a user interface configuration unit, comprising: a display unit; a driver including a user interface to set options of a printer and to display the user interface on the display unit, the user interface including a main window, at least one main menu provided in the main window, and at least one submenu linked to each main menu; and an input device to set an option of converting a selected submenu of the at least one submenu to be converted to a main menu to be displayed at the main window.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a structure chart of a conventional user interface;

FIGS. 2A through 2C exemplary illustrate a conventional user interface for setting functions;

FIG. 3 is a block diagram of a user interface configuration apparatus according to an embodiment of the present general inventive concept;

FIGS. 4A and 4B illustrate user interfaces according to an embodiment of the present general inventive concept;

FIGS. 5A and 5B illustrate user interfaces describing a method of adding a submenu into a main window as a main menu according to an embodiment of the present general inventive concept;

FIG. 6 is a flowchart of a method of adding a submenu in a main window as a main menu according to an embodiment of the present general inventive concept;

FIG. 7 is a flowchart of a method of deleting a submenu added in the main window from the main window according to an embodiment of the present general inventive concept; and

FIG. 8 is a flowchart of a method of reconfiguring a main menu and a submenu to an initial configuration according to an embodiment of the present general inventive concept.

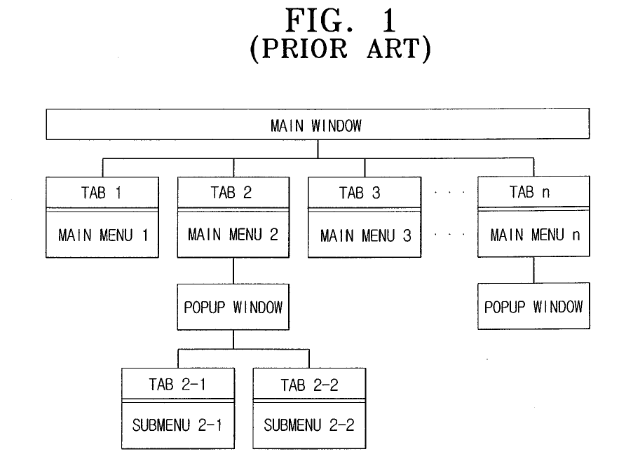

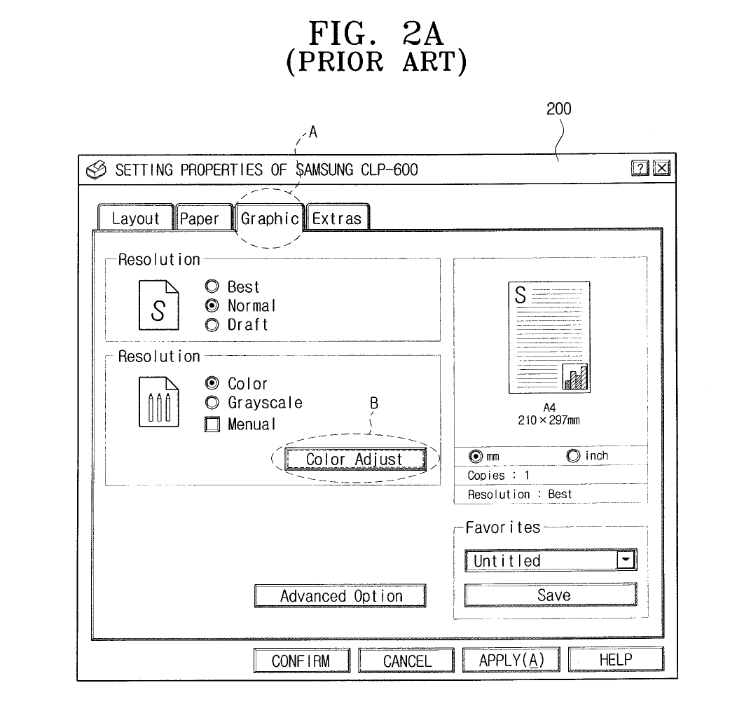

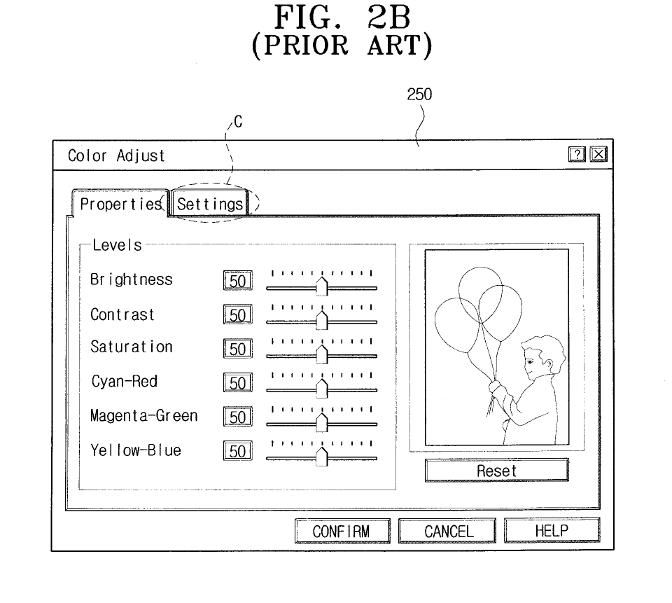

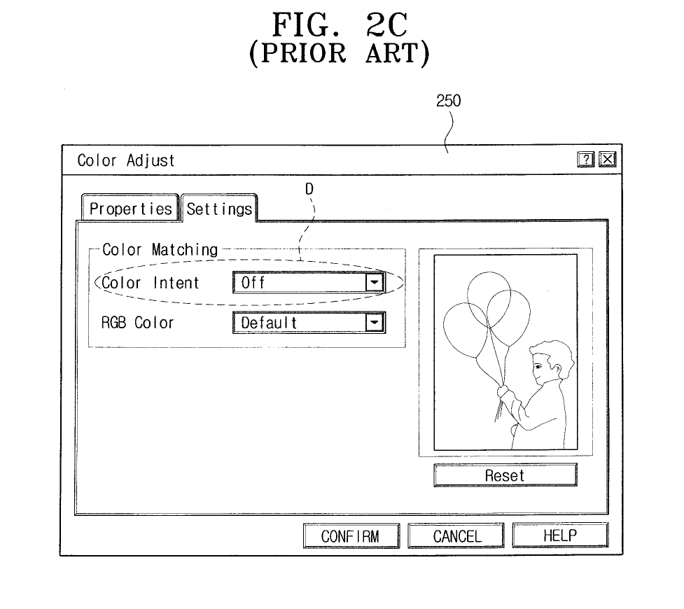

### DETAILED DESCRIPTION OF THE PREFERRED EMBODIMENTS

Certain embodiments of the present general inventive concept will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

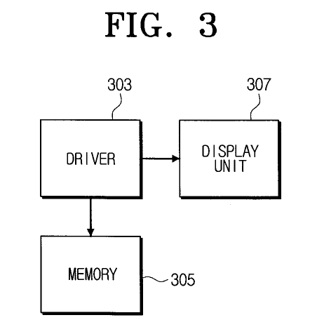

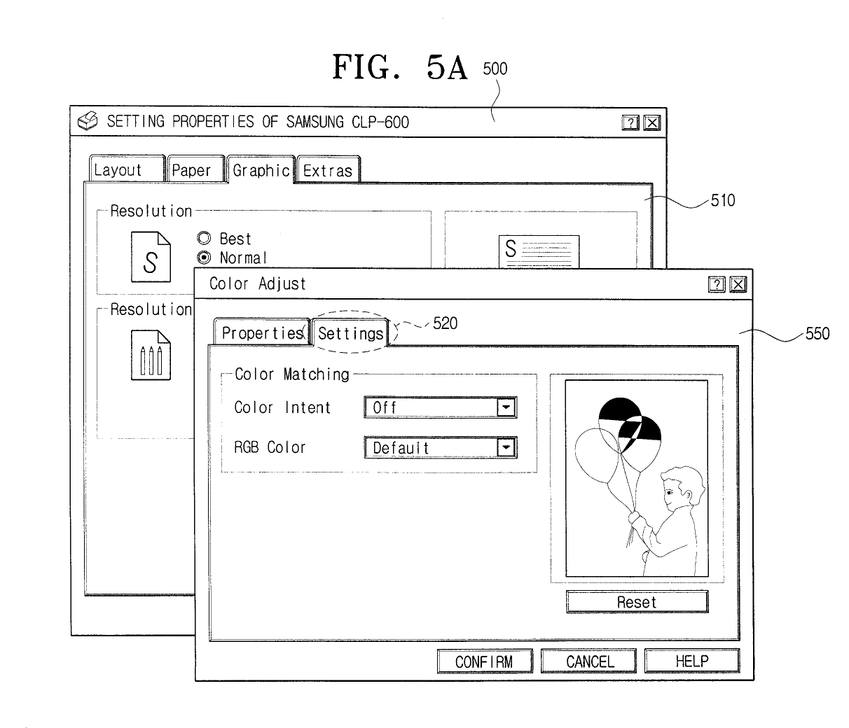

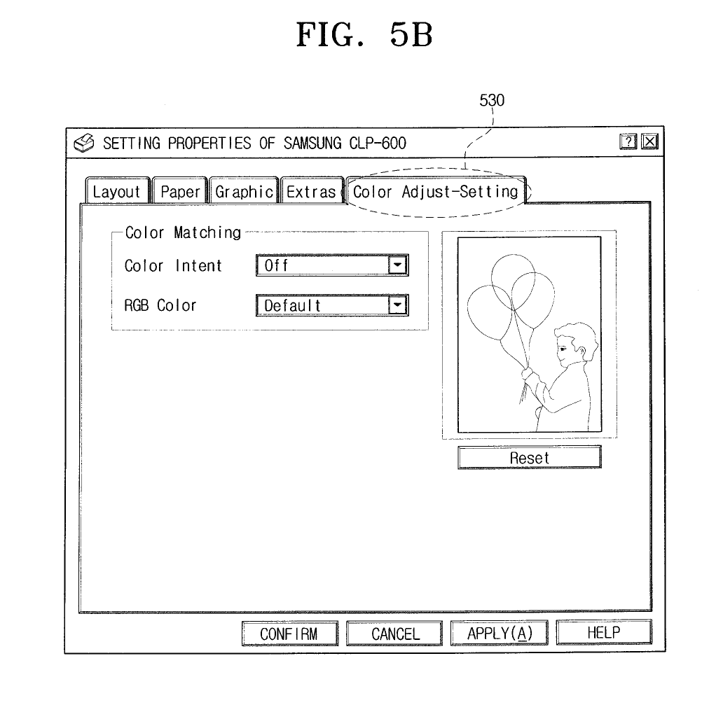

FIG. 3 is a block diagram illustrating a user interface configuration apparatus of a printer driver according to an embodiment of the present general inventive concept. FIGS. 5A and 5B are exemplary user interfaces illustrating a method of adding a submenu to a main window as a main menu according to an embodiment of the present general inventive concept.

Referring to FIGS. 3, 5A and 5B, the user interface apparatus includes a driver 303, a memory 305 and a display unit 307.

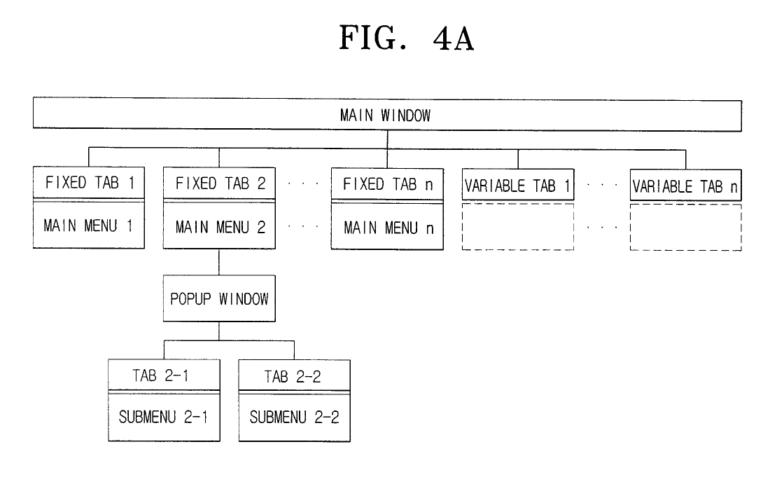

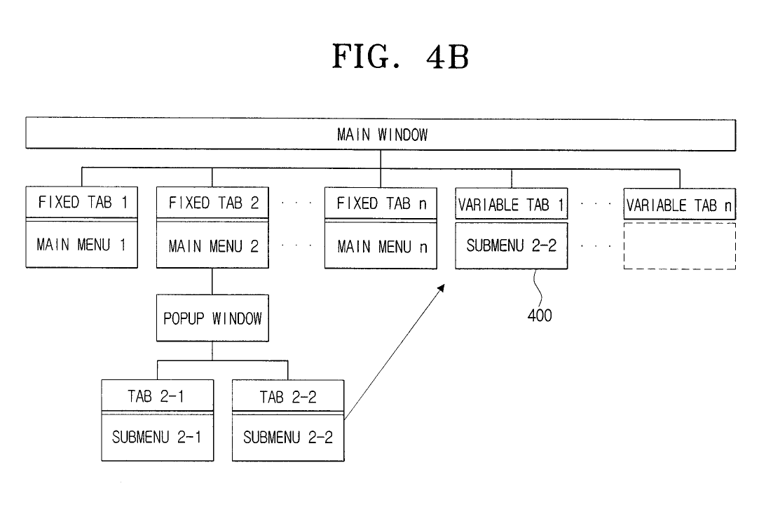

The driver 303 configures a user interface according to an embodiment of the present general inventive concept and provides the user interface through the display unit 307. The driver 303 may configure a main window having at least one main menu as illustrated in FIG. 4A. Also, the driver 303 may configure a popup window linked to the main menu which has at least one submenu. Herein, the term ‘driver’ refers to a software program configuring user interfaces and displaying the configured user interface according to the present general inventive concept, or refers to a hardware apparatus performing the software program thereof.

The driver 303 according to the present embodiment is a printer driver that provides a user interface to set options of the printer. Such a user interface includes a main menu and submenus. The main menu, for example, may be a menu to set a size of a printing paper, a resolution, a layout of the printing paper, a paper tray or an n-up. The main window includes at least one of the described main menus. The main window is displayed at the display unit 307, and a user may recognize at least one of the main menus in the main window and set a target option through selecting the corresponding main menu.

The submenu is a supplementary menu to set detail options of the main menu. For example, a submenu may be a menu that allows the user directly to set a size of the printing paper which is not provided in a main menu to set the size of the printing paper. The submenu may be provided as a popup window. In some embodiments of the present general inventive concept, a submenu may be occasionally provided as a popup window when it is required. It is possible that at least one submenu is linked to a predetermined tab of each main menu.

The driver 303 according to the present embodiment can add a submenu to a main window as a main menu when a user selects an option of adding a submenu to a main window through an input device (not shown). Alternatively, the driver 303 can also provide an option to delete an added submenu from a main window.

Herein, the input device (not shown) may be a key board and/or a mouse. The selection of a user, which can be inputted through the input device, is recognized by the driver 303, and then the driver 303 performs necessary operations according to the selection of the user.

The driver 303 can manage the number of main menus in the main window not to exceed a predetermined number. Herein, the number of the main menus can be changed. When a user selects an option of adding a submenu into a main window, the driver 303 determines whether the number of main menus in the main window is in a predetermined range if the selected submenus are added into the main menu. If the number of main menus exceeds the predetermined range, the driver 303 does not add the selected submenu into the main window. It is possible that a message that indicates a reason of not adding the selected submenu into the main window is provided to the user.

Also, the driver 303 determines whether a selected submenu 520 of a popup window 550 is already included in a main menu of a main window 500. In order to make this determination, the driver 303 may reference a current configuration of the main window and the sub windows stored in the memory 305.

It is possible that the memory 305 stores an initial configuration of the main menu and the submenu in order to reconfigure the current configuration to the initial configuration when a user selects an operation of initializing (described in further detail infra).

The display unit 307 may display a user interface configured by the driver 303.

The memory 305 may store a configuration of a main window and popup windows. It is possible that the memory 305 may store a current configuration of a main window and a popup window restructured by the driver 303 and an initial configuration thereof. The memory 305 may store predetermined setting values. Such setting values includes a setting value denoting the current configuration and the initial configuration of the main menu and the submenu.

Hereinafter, a method of adding a submenu 520 of a popup window 550 into a main window 500 as a main menu by a driver 330 will be described. The driver 303 may add the submenu 520 as the main menu by modifying a setting value and storing a modified setting value in the memory 305. Based on the modified and stored setting value, the driver 303 configures the popup windows and the main window and displays it on the display unit 307. It is possible that the memory 305 may back up the setting value of the initial configuration of the user interface when the setting value is modified.

Similarly, the driver 303 may delete a submenu 530 added in the main window 500. That is, the driver 303 modifies the setting value of the current configuration of the user interface, which is stored in the memory 305, to delete the added submenu 530 from the main window 500.

If a user selects an option to restore the initial configuration of the user interface, the driver 303 changes the current setting value to the initial setting value of the user interface.

According to the embodiment of the present general inventive concept, the main menu 510 of the main window 500 includes tabs of main menus which are an identification of each main menu 510 according to each function. When the user selects one of the tabs, the driver 303 displays the corresponding main menu 510 on the display unit 307 in response to the user's selection. The submenu may also include tabs for submenus.

For example, the adding a submenu 520 of popup window 550 in to the main window 500 as a main menu may be performed as follows.

At first, a user selects a tab of a submenu 520 of a popup window 550 by using a mouse and drags the selected tab into a predetermined area in the main window 500 with a predetermined key, i.e., ctrl, alt or shift, being pressed.

Secondly, a user selects a tab of a submenu 520 of a popup window 550, clicks a right button of the mouse to display a selection menu having an option of ‘adding to a main menu’, and selects the option.

Thirdly, a user checks an option box inside a submenu 520 of a popup window 550.

Fourthly, a user uses a predetermined short-key with the submenu 520 of a popup window 550 being activated.

As described above, the option of adding can be selected through an input device (not shown) by a user.

FIGS. 4A and 4B are illustrations of a user interface structure chart according an embodiment of the present general inventive concept.

Referring to FIG. 4A, a user interface structure is a tree structure having a main window as a higher layer and a popup window as a lower layer. The main window includes a plurality of main menus 1 to n with corresponding constant tabs 1 to n) and addable menus with variable tabs 1 to n. The popup window includes a plurality of submenus 2-1 and 2-2 and corresponding tabs 2-1 and 2-2.

The main menus with the constant (fixed) tabs denote an initial configuration of the main window while the main menus with the variable tabs are submenus added into the main window by a user.

Therefore, when the main window is displayed initially, the main menus with the variable tabs 1 to n may not be displayed.

FIG. 4B illustrates a user interface structure when the submenu of the popup window is added in the main window as the main menu.

Referring to FIG. 4B, if the submenu 2-2 of the popup window is added into the main window as the main menu, the submenu 2-2 may be displayed as the submenu 2-2 of the main window or the submenu 2-2 with the variable tab 1 400.

FIGS. 5A and 5B exemplary illustrate a user interface of a method of adding a submenu as a main menu according to an embodiment of the present general inventive concept.

Referring to FIGS. 5A and 5B, the illustrated user interface is a user interface to select properties of a printer in a MS window type operating system, i.e., Windows 2000 professional. The illustrated user interface includes main menus of ‘Layout’, ‘Paper’, ‘Graphic’ and ‘Extras’. By selecting each tab of corresponding main menus, a sub user interface is displayed to set detail properties related to the selected main menu. For example, the tab of main menu ‘Graphic’ is selected in FIG. 5A.

If the tab of main menu ‘Graphic’ is selected in the main window 500 and then a tab (not shown) of a main menu 510 ‘Color adjust’ is selected, a popup window 550 for ‘Color adjust’ is displayed. The popup window 550 may include submenus ‘Properties’ and ‘Settings’.

Hereinafter, a method of adding the submenu ‘Settings’ in to a main window as a main menu will be described.

A user selects a tap of ‘Settings’ in a popup window 550 of ‘Color adjust’ and drags the selected tab into a predetermined area of the main window 500 with a predetermined key being pressed using the mouse. Then, the driver 303 adds a new main menu ‘Color Adjust-Settings’ to the main window 500. FIG. 5B illustrates the main menu ‘Color Adjust-Settings’ newly added to the main menu 530.

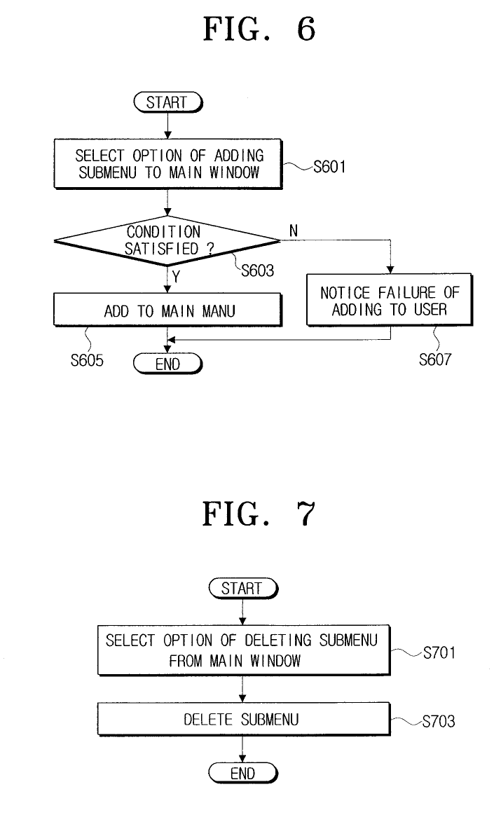

FIG. 6 is a flowchart of a method of adding a submenu into a main window as a main menu according to an embodiment of the present general inventive concept.

Referring to FIGS. 6 and 3, if a user selects an option of adding a submenu through an input device (not shown) in operation S601, the driver 303 receives the selection of the adding option and determines whether the adding option satisfies a predetermined condition in operation S603. For example, the driver 303 can determine whether the number of main menus will exceed the maximum number of the main menus in the main window if the selected submenu is added to the main window, or whether the submenu is already included in the main window. If such a condition is satisfied in operation S603:Y, the driver 303 modifies a setting value of a current user interface configuration stored in the memory 305 corresponding to the user's command. As a result, the selected submenu of the popup window is added into the main window as the main menu in operation S605. If the condition is not satisfied in operation S603:N, the driver 303 transmits the result of the determination to the display unit 307. The display unit 307 displays a message indicating a failure of adding the submenu in operation S607. It is to be noted that the predetermined conditions to determine whether to add a submenu are not limited to the above listed conditions, and may include additional predetermined conditions to determine adding a submenu to the main menu.

FIG. 7 is a flowchart of a method of deleting a submenu from a main window according to an embodiment of the present general inventive concept.

Referring to FIGS. 7 and 3, if a user selects an option of deleting an input device (not shown) in operation S701, the driver 303 receives the selection of the deleting option and deletes the selected submenu from the main window by modifying the setting value of the current configuration corresponding to the user's command, in operation S703.

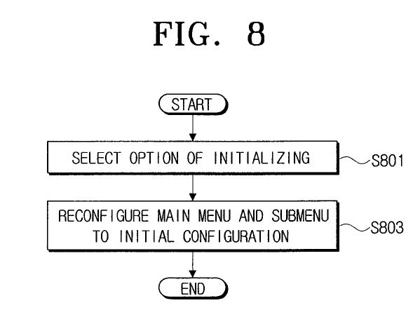

FIG. 8 is a flowchart of a method of restoring an initial configuration of a main menu and a submenu according to an embodiment of the present general inventive concept.

Referring to FIGS. 8 and 3, if a user selects an option of restoring (to initial configuration) an input device (not shown) in operation S801, the driver 303 receives the selection of the initializing option and reconfigures the main menu and the submenu into the initial configuration by modifying the setting value of a current user interface configuration to the initial setting value of initial user interface configuration stored in the memory 305, in operation S803.

The user interface configuration of the printer driver is used as an example to describe the present general inventive concept. However, the present general inventive concept can be identically implemented with any user interface configuration of other interface cards that requires installation of a corresponding driver, such as a network interface card. Since a user interface of the network interface card or a video interface card have same configurations similar to that of the printer, drawings and detailed descriptions thereof are omitted. However, the present general inventive concept is not limited to the printer driver.

The above described methods according to various embodiments of the present general inventive concept can be embodied as a program and stored on a computer readable recording medium. The computer readable recording medium can be any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, frequently used functions can be used conveniently and rapidly according to the driver configuring a user interface, the user interface apparatus and the method thereof according to the present general inventive concept. Therefore, operation efficiency is improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of configuring a user interface providing a main window having at least one main menu and a popup window linked to each of the main menus and having at least one submenu, the method comprising adding a submenu into the main window as the main menu when an option of adding a submenu is selected.

2. The method of claim 1, further comprising:
deleting a selected submenu added to the main window as a main menu from the main window when an operation of deleting is selected.

3. The method of claim 1, further comprising:
restoring a current configuration of the main menu and the submenu to an initial configuration when an option of initializing is selected.

4. The method of claim 1, wherein the number of the main menus in the main window is variable.

5. The method of claim 1, wherein the submenu is not added to the main window as the main menu when a predetermined condition that the submenu is already in the main window is determined.

6. The method of claim 5, wherein a failure of adding the submenu into the main window is indicated to a user.

7. The method of claim 1, wherein the option of adding a submenu is selected by using a mouse, checking an option box or using a short-key.

8. A driver configuring a user interface including a main window having at least one main menu and a popup window linked to each of the main menus and having at least one submenu, the driver comprising an option of adding one or more of the at least one submenu to the main window as a main menu when the option of adding is selected.

9. The driver of claim 8, further comprising an option of deleting a selected submenu added to the main window when the option of deleting is selected.

10. The driver of claim 8, further comprising an option of restoring a current configuration of the main menu and the submenu to an initial configuration when the option of restoring is selected.

11. The driver of claim 10, further comprising a storing unit for storing the initial configuration of the main menu and the submenu.

12. The driver of claim 8, wherein the number of the main menus in the main window is variable.

13. The driver of claim 8, wherein the submenu is not added into the main window if the submenu is determined to already be in the main window.

14. The driver of claim 13, wherein the failure of adding the submenu is indicated to a user.

15. The driver of claim 8, wherein the option of adding is selected by using a mouse, checking an option box or using a short-key.

16. A method of adding a submenu as a main menu to a main window of a user interface of a printer driver, the method comprising:
selecting an option of adding a select submenu among a plurality of submenus to a main window through an input device;
reprogramming the selected submenu to be a main menu displayed on the main window if predetermined conditions are met, otherwise indicating that the selected submenu is not being added to the main window as a main menu together with the one or more predetermined conditions that were not met.

17. The method of claim 17, further comprising:
deleting the selected submenu added to the main window as a main menu from the main window when an operation of deleting is selected.

18. The method of claim 17, further comprising:
restoring a current configuration of the main menu and the submenu to an initial configuration when an option of initializing is selected.

19. A user interface configuration unit, comprising:
a display unit;
a driver including a user interface to set options of a printer and to display the user interface on the display unit, the user interface including a main window, at least one main menu provided in the main window, at least one submenu linked to each main menu, and a determination unit to determine whether the selected submenu will be converted to a main menu based on whether predetermined conditions are met; and
an input device to set an option of converting a selected submenu of the at least one submenu to be converted to a main menu to be displayed at the main window.

20. The user interface configuration unit of claim 19, wherein the predetermined conditions includes:
whether the number of main menus will exceed the maximum number of the main menus in the main window if the selected submenu is added into the main window; and
whether the submenu is already included in the main window.
